(19) United States
(12) Patent Application Publication
(10) Pub. No.: US 2026/0203597 A1
(43) Pub. Date: Jul. 16, 2026

(54) AUTO-MERGING DECENTRALIZED-TRAINING METADATA IN MACHINE LEARNING TRACKING PIPELINE

(71) Applicant: HEWLETT PACKARD ENTERPRISE DEVELOPMENT LP, Spring, TX (US)

(72) Inventors: Divya C. Nambiar, Bangalore (IN); Saikat Mukherjee, Bangalore (IN); Annmary Justine Koomthanam, Fort Collins, CO (US); Suparna Bhattacharya, Bangalore (IN)

(21) Appl. No.: 19/089,863

(22) Filed: Mar. 25, 2025

(30) Foreign Application Priority Data
Jan. 13, 2025 (IN) 202541002833

(51) Int. Cl. G06F 16/25

(52) U.S. Cl. CPC G06N 3/098

(57) ABSTRACT

Systems and methods are provide for tracking metadata generated by distributed data processing pipelines. An empty execution template representative of a metadata tracking hierarchy can be distributed to a plurality of nodes comprising a distributed artificial intelligence (AI) network. Individual instances of the empty execution template which individual nodes of the plurality of nodes have populated with metadata arising out of the execution of one or more stages of an AI pipeline at the individual nodes, can be received from the plurality of nodes. The metadata from the individual nodes can be merged in accordance with a common execution identifier set forth in the execution template. A global AI pipeline with the merged metadata to facilitate distributed data processing operations with the merged metadata can be created.

### BACKGROUND

A data processing pipeline may refer to a series of executions (i.e., processing steps) that transform one or more data artifacts (e.g., raw data, datasets, analytical or machine learning (ML) models derived from data, etc.) into one or more new data artifacts (e.g., new datasets, analytical or ML models derived from data, dashboards displaying one or more of the foregoing data-artifacts, etc.). In many cases, such data processing pipelines are comprised of processing stages (e.g., a data discovery/preparation stage, an ML model preparation stage, an ML model training stage, an ML model validation/testing stage, etc.). A given processing stage may be comprised of one or more executions. An execution may be a data processing step/unit that transforms one or more data artifacts. In other words, an execution may receive one or more input data artifacts (i.e., data artifacts received as inputs to the execution), and transform them into one or more output data artifacts (i.e., data artifacts produced by the execution). A data artifact may be an output from one execution, and/or an input into one or more different executions, and so on.

Oftentimes, to leverage the advantages of distributed computing, the multiple processing stages of a data processing pipeline may be performed by different data processing sites (e.g., different datacenters, edge computing sites, etc.). Data processing pipelines performed across multiple data processing sites may be referred to as “distributed data processing pipelines.” In many cases, the data processing sites of a distributed data processing pipeline can be connected to a central repository (e.g., a central datacenter) for storing data artifacts consumed/produced by the distributed data processing pipeline.

Interactions in distributed data processing pipelines can be highly complex. As described above, distributed data processing pipelines can consist of multiple processing stages distributed across various data processing sites. Each processing stage may include multiple executions which transform data artifacts.

### BRIEF DESCRIPTION OF THE DRAWINGS

The present disclosure, in accordance with one or more various examples, is described in detail with reference to the following figures. The figures are provided for purposes of illustration only and merely depict typical or examples.

FIG. 1 depicts an example distributed data processing pipeline, in accordance with various examples of the presently disclosed technology.

FIG. 2A depicts an example data processing pipeline tracking hierarchy and framework for a distributed data processing pipeline, in accordance with various examples of the presently disclosed technology.

FIG. 2B is a more detailed depiction of the example data processing pipeline tracking hierarchy for a distributed data processing pipeline, in accordance with various examples of the presently disclosed technology.

FIG. 3 depicts an example of the functional flow of the example data processing pipeline tracking hierarchy for a distributed data processing pipeline, in accordance with various examples of the presently disclosed technology.

FIG. 4 is depicts an example computing system that may be used to efectuate data processing pipeline tracking hierarchy for a distributed data processing pipeline, in accordance with various examples of the presently disclosed technology.

FIG. 5 depicts a block diagram of an example computer system in which various of the examples described herein may be implemented.

The figures are not exhaustive and do not limit the present disclosure to the precise form disclosed.

### DETAILED DESCRIPTION

Within a data processing pipeline (distributed or otherwise), there are often dependencies between processing stages and executions, which can affect performance metrics for ultimate/downstream output data artifacts of the data processing pipeline (e.g., datasets, ML models, etc.). In other words, data artifacts consumed/produced (along with performed executions) in an earlier processing stage of a data processing pipeline may influence data quality metrics (e.g., ML model accuracy) for data artifacts produced in later processing stages of the data processing pipeline. Moreover, it can be important to track metadata across a data processing pipeline to provide functionality like data lineage tracking, provenance and reproducibility.

A common metadata framework (CMF) can be used to collect and store information associated with data processing pipelines, such as AI/ML pipelines. Such a CMF can employ application programming interfaces (APIs) to query metadata, where the CMF uses a data-first approach such that all artifacts, metadata, or metrics (also referred to herein, as “associated data” or “related data”) recorded by the CMF are versioned and can be identified by their content hash.

CMF can use abstractions referred to as “Pipeline,” “Context,” and Executions” to store the metadata, artifacts, or metrics of data processing pipelines. Each pipeline can have a name provided by a user upon initializing the CMF. Each stage can be represented by a context object. Metadata, metrics, or artifacts associated with each run of a stage can be captured in an execution object or unit. Inputs and outputs of executions can be logged as a dataset, model, or metrics, while parameters of executions can be recorded as properties of executions.

A CMF object is responsible for running a CMF backend to record pipeline metadata, by internally creating a pipeline abstraction that groups individual stages as well as the stages'executions. Stages, their executions, and artifacts, metadata, or metrics produced by/from such stages and their execution can be associated with a pipeline having a given name.

A pipeline can have multiple stages, as noted above, and each stage can be associated with multiple executions. A stage can be thought of as a class in object-oriented programming, and a context (stage description) defines what a corresponding stage looks likes (name and optional properties). Every run of a stage can be marked as an execution, where the aforementioned APIs can track the metadata, artifacts, or metrics associated with an execution, such as a stage parameters (e.g., the number of epochs and learning rate for training stages). As also noted above, a stage execution can consume (inputs) and produce (outputs) multiple artifacts (such as, e.g., datasets, models, and performance metrics). Artifacts may have optional metadata associated with them, e.g., feature statistics for ML datasets or useful parameters for ML models (e.g., the number of trees in a random forest classifier).

However, tracking artifacts, metrics, or metadata, and data lineages for distributed data processing pipelines presents a significant challenge which existing technologies have struggled to address. Related factors that can make comprehensive and consistent tracking of data lineages and metadata/artifacts/metrics for distributed data processing pipelines difficult include: (1) different data processing sites commonly assigning identical names to, e.g., data artifacts which are not identical; and (2) different data processing sites commonly assigning different names to data artifacts which are identical. As alluded to above, such data artifact (as well as metrics or metadata) naming inconsistencies can present a significant challenge when it comes to tracking such associated data and data lineages for a distributed data processing pipeline

Examples of the disclosed technology are directed to improving the tracking of related data associated with or input to/output from a distributed, multi-stage pipeline, such as artifacts, metrics, or metadata (defined and explained in greater detail below).

A Federated CMF (FCMF), like the aforementioned CMF employs a tracking hierarchy (Pipeline→Stage/Context→Execution), whereby stage-specific data can be tracked locally by associating or correlating the related data with a unique execution ID, and later aggregating the related data across different stages/contexts performed at difference nodes/sites at a central server to build a global pipeline. An example of such a FCMF is described in co-owned, and co-pending US Patent Publication 2023/0418792A1, which is incorporated herein by reference in its entirety.

However, per-stage executions can be assigned different, unique IDs for tracking purposes, and have historical importance/existence. Thus, per-stage executions are not, and cannot be merged. For example, a user may wish to perform multiple executions of a particular data processing pipeline stage, such as a training stage where the user alters, e.g., a hyperparameter, for each execution of the training stage. In the context of determining an optimal hyperparameter, the user may wish to understand the artifacts generated during each training stage execution to understand the accuracy associated with the execution of an ML model, or the learning rate for training stages. If historical executions were merged, this data engineering would be stymied. Thus, even with conventional FCMF, tracking related data, such as metadata associated with the execution of the same stage across different nodes or sites is not possible.

Thus, examples of the disclosed technology provide an empty “template” or pipeline for multi-stage tracking that can be created at a centralized FCMF server for each execution run. The different nodes in the distributed, multi-stage pipeline can pull the empty template from a centralized FCMF server, and can proceed with executing the stages. However, unlike conventional FCMF, the empty template provides a pipeline that identifies executions with the same ID, regardless of where/at what node the execution of a stage(s) occurs. In this way, the nodes can push their individual artifacts, metrics, ormetadata to the centralized FCMF server, where they can be merged. As can be appreciated, the ability to function in accordance with a GIT-like push/pull mechanism is maintained from FCMF, but the merging function is no longer prohibitive regarding distributed executions.

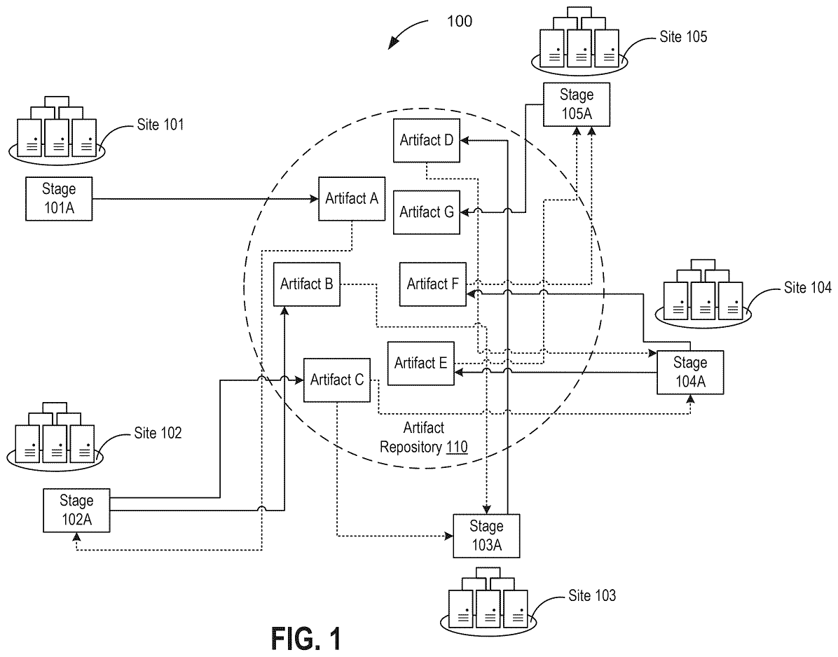

FIG. 1 depicts an example distributed data processing pipeline 100, in accordance with various examples of the presently disclosed technology.

As depicted, distributed data processing pipeline 100 comprises five processing stages (i.e., processing stages 101A, 102A, 103A, 104A, and 105A) performed by five data processing sites (i.e., data processing sites 101, 102, 103, 104, and 105) respectively. Each data processing site may be e.g., a datacenter, an edge computing site, etc. The multiple data processing sites of distributed data processing pipeline 100 may be disconnected from each other, but may be at least intermittently connected to data artifact repository 110. As will be described below, data artifact repository 110 may be a (logically) central server that stores the data artifacts (i.e., data artifacts A-G) consumed and/or produced during executions of data processing pipeline 100. As noted above, and as will described in greater detail below, metadata, metrics, as well as artifacts can tracked and stored. Accordingly, any mention of, e.g., one related or associated data type, is not necessarily limiting. In other words, and while example distributed data processing pipeline 100 cites the storage of artifacts, the example distributed data processing pipeline 100 can also store metrics and metadata as needed or desired.

Data processing site 101 may perform/execute processing stage 101A of data processing pipeline 100 (e.g., a data discovery/preparation stage). In various examples, this may be the first processing stage of distributed data processing pipeline 100. Data processing site 102 may perform processing stage 102A of data processing pipeline 100 (e.g., an ML model preparation stage). In various examples, this may be the second processing stage of distributed data processing pipeline 100. Data processing site 103 may perform processing stage 103A of distributed data processing pipeline 100 (e.g., an ML model training stage). In various examples, this may be the third processing stage of distributed data processing pipeline 100. Similarly, data processing sites 104 and 105 may perform processing stage 104A and 105A respectively. In various examples, processing stages 104A and 105A may be the fourth and fifth processing stages of distributed data processing pipeline 100.

At a given processing stage, a given data processing site may perform one or more executions for the given processing stage. An execution may be a data processing step that transforms one or more data artifacts. In other words, an execution may receive one or more input data artifacts (i.e., data artifacts received as inputs to the execution), and transform them into one or more output data artifacts (i.e., data artifacts produced by the execution). A data artifact (including data artifacts A-F) may be a data-related input or output of distributed data processing pipeline 100 (e.g., raw data, a processed dataset, an analytical or ML model derived from data, etc.). A data artifact may be an output from one execution, and/or an input into one or more different executions. For example, as depicted, data artifact B is an output from a first execution of processing stage 102A, and an input to a first execution of processing stage 103A. Similarly, data artifact C is an output from a second execution of processing stage 102A, and in input into both a first execution of processing stage 103A and a first execution of processing stage 104A.

As illustrated by even the simplified example of FIG. 1, distributed data processing pipelines may comprise a complex network of data transformations/executions where a given data artifact may be an input to, and/or output from, multiple executions of the distributed data processing pipeline. As these executions are performed across multiple data processing sites, this network of transformations/executions can become even more complex and difficult to track.

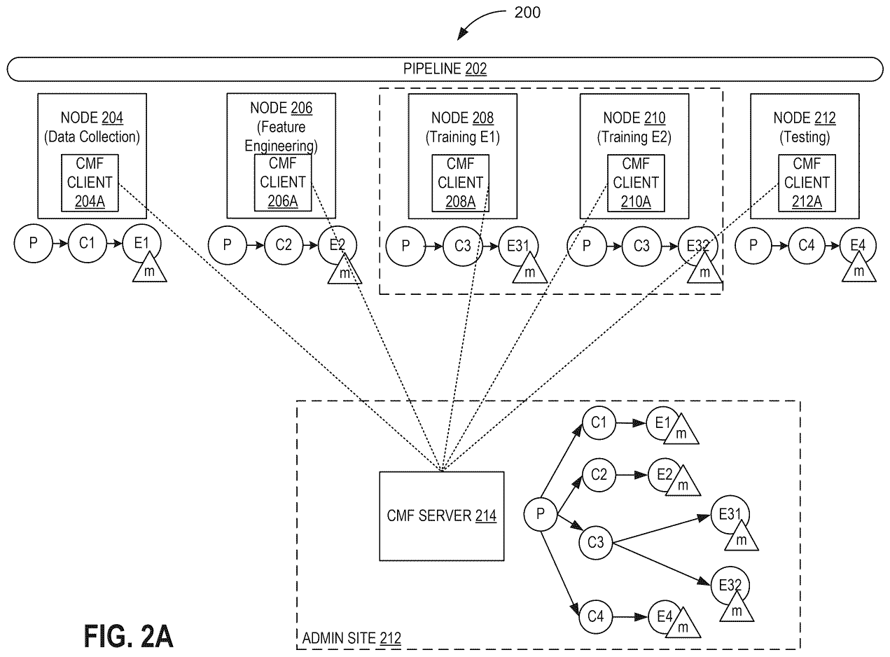

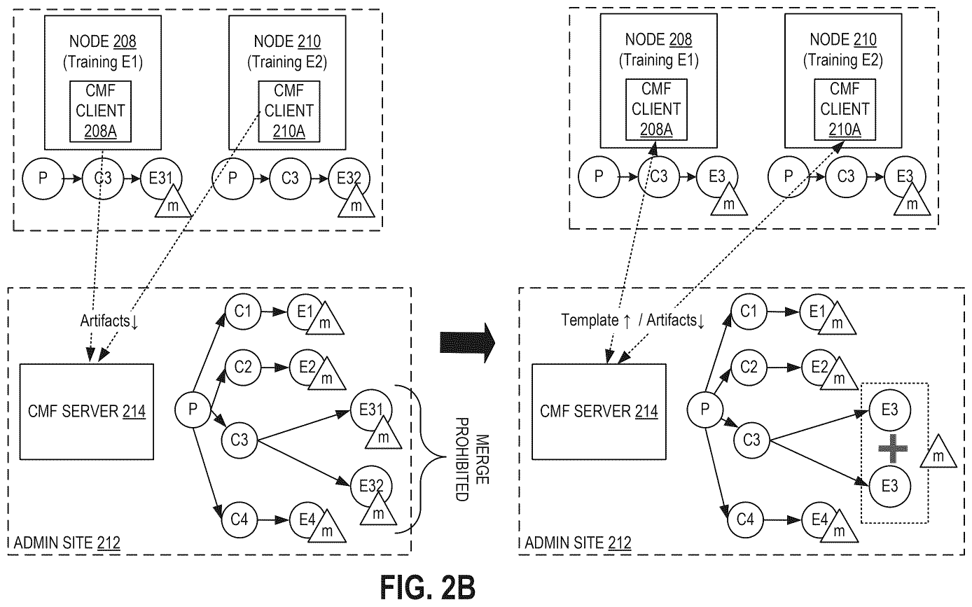

FIG. 2A depicts an example of distributed data processing pipeline tracking 200 using a data processing pipeline tracking hierarchy for a data processing pipeline 202 in accordance with various examples of the presently disclosed technology.

As described above, examples of the presently disclosed technology can track associated data, such as metadata, artifacts, or metrics across distributed data processing sites. Accordingly, data processing pipeline tracking hierarchy 200 may track associated data of an entire distributed data processing pipeline 202, which contains multiple processing stages being executed at different nodes of different sites. In this example, one of these processing stages, a training stage, is further divided or distributed by virtue of the stage being performed/executed by different data processing nodes at different sites.

As illustrated in FIG. 2A, utilizing different abstraction levels, examples of the presently disclosed technology can assign a unique identifier (e.g., a pipeline name) to each unique data processing pipeline they operate on. These unique identifiers may be used to compile/log the processing stages, executions, input/output events, and data artifacts—associated with a given data processing pipeline. Here, pipeline 200 is given the pipeline name “P,” which can be used to track any metadata/artifacts/metrics generated by the execution of a stage associated with pipeline P.

As depicted, the next level below/following the data processing pipeline level named “P” is the processing stage level. A given data processing pipeline may be comprised of multiple processing stages (e.g., a data collection/preparation stage, an ML model preparation/feature engineering stage, an ML model training stage, an ML model testing stage, etc.). As noted above, examples of the presently disclosed technology may track metadata/artifacts/metrics generated by data processing pipelines even when multiple processing stages are performed across different data processing sites, and even when a single processing stage is performed across different data processing sites.

Utilizing this tracking abstraction, examples of the presently disclosed technology may assign a unique identifier (e.g., a processing stage name) to each unique processing stage of a given data processing pipeline. These unique identifiers may be used to compile/log the executions, input/output events, and related data (artifacts, metadata, metrics) associated with a given processing stage. In this example, a data collection stage of data processing pipeline 202 is being performed by a node 204. CMF client 204A may be a client corresponding to CMF server 214 (representative of a client-server relationship) running on node 204. Tracking of this particular stage or context can be facilitated by assigning a name or ID to the stage, in this example, “C1.” Node 204 may also collect the code (or at least a version of the code) used to collect the data, which can be, e.g., raw data artifacts. Such code may be associated with executions used to collect the raw data artifacts. As used herein, artifacts can refer to the outputs or byproduct data produced during pipeline execution, such as trained models, evaluation metrics, visualization data, and so on. In the CMF context, artifacts can be considered as having a separate existence as files or objects. For example, in a training and validation stage, artifacts can refer to metadata or metrics that are stored as a file, object, or other similar format (e.g., performance graph, matrix table stored in a file, etc.). In a testing stage, artifacts can be test-related metrics or metadata that are stored as a file, object, or image, or other format. In a pre-processing stage, artifacts may be metadata or metrics (stored as a file, object, etc.) representing a frequency graph, standard deviation variance chart, and so on.

Metadata can refer to descriptive information about (other) data, processes, or stages in an AI pipeline, whereas metrics generally refer to performance results. Thus, metadata and metrics can characterized or explained as being data of data, various control parameters, performance results, or some other stage's data byproduct. In a training or validation stage, metadata can refer to data related to/associated with training and validation, process, training, hyper-parameters, etc., such as an epoch, learning rate, batch size, and so on. Metrics can refer to training and validation-related performance data, such as accuracy, sensitivity, specificity data, etc. Similarly, for a testing stage, metadata can refer to test-related data (e.g., iteration, batch size data), while metrics can refer to test-related performance data (e.g., accuracy, sensitivity data, etc.). In a pre-processing context, metadata can be data related to original or processed data, such as quantity, quality, labels, frequency, categories, and the like. Metrics are typically not associated with or generated by the pre-processing stage.

In addition to collecting raw data artifacts and the code (or at least a version of the code) used to collect them, node 204 also creates metadata associated with the collected raw data artifacts. The created metadata for a given collected raw data artifact can comprise a hash content value that identifies the given collected raw data artifact, and an indication that the given collected raw data artifact was an output of a given execution of the raw data acquisition stage.

The next level below or following the processing stage level, is an execution level. A given processing stage may be comprised of one or more executions. An execution may be a data processing step that transforms one or more data artifacts. In other words, an execution may receive one or more input data artifacts (i.e., data artifacts received as inputs to the execution), and transform them into one or more output data artifacts (i.e., data artifacts produced by the execution).

Utilizing this tracking abstraction level, examples of the presently disclosed technology may assign a unique identifier (e.g., an execution name) to each unique execution of a processing stage. These unique identifiers may be used to compile/log input/output events, and related data—associated with a common execution. In this example, the execution of the data collection stage being performed by node 204 can be identified as “E1.” The metrics/metadata/artifacts associated with the performance or execution of a stage are identified as “m.” Thus, the tracking hierarchy for the data collection stage performed by node 204 is “P→C1→E1.”

Similarly, a data processing stage relating to feature engineering can be performed by a node 206 (with a CMF client 206A corresponding to CMF server 214). The tracking hierarchy associated with this feature engineering data processing stage can be reflected as “P→C2→E2,” with metrics/metadata/artifacts “m” being associated with execution unit or ID E2. As can be appreciated, the feature engineering data processing stage belongs to or is associated with the same data processing pipeline, P. However, this being a different processing stage, the tracking hierarchy reflects a different stage identifier, C2 versus C1 (which identifies the data collection data processing stage performed by node 204).

A data processing stage relating to testing can be performed by a node 212 (and corresponding CMF client 212A relative to CMF server 214). The tracking hierarchy associated with this testing data processing stage can be reflected as “P→C4→E4,” with metrics/metadata/artifacts “m” being associated with execution unit or ID E4. As can be appreciated, the testing data processing stage belongs to or is associated with the same data processing pipeline, P. However, and again, being a different processing stage, the tracking hierarchy reflects a different stage identifier, C4 versus C1 and C2 (which identifies the data collection data processing stage performed by node 204, and the feature engineering data processing stage performed by node 206).

In the illustrated example of FIG. 2A, data processing pipeline 202 includes a training data processing stage. However, unlike the other data processing stages (data collection, feature engineering, and testing), the training data processing stage is further distributed between two nodes, nodes 208 and 210. That is, a user or entity in control of pipeline 202 may desire to distribute the training of an ML model across multiple nodes. This can be the result of a desire to leverage federated learning, for example. That is, each of a plurality nodes may train local instances of an ML algorithm with a training dataset(s) local to each of the nodes with the intent of aggregating parameters resulting from the local training to ultimately create a global ML model. There can be a variety of reasons why this would be done, e.g., the developer of the ML model may wish to leverage a variety of training datasets, yet keep the training datasets private for the benefit of the training dataset providers. In other examples, the use of federated learning can combat overfitting by training an ML model across different training datasets.

Accordingly, the data processing stage relating to training can be performed by node 208 and node 210, each running a respective CMF client 208A and 210A that executes a training stage. It should be understood that CMF clients 208A and 210A are different CMF clients that are performing the same training/are part of the same training process using their own local training data. It should be noted that CMF/FCMF utilizes a client-server architecture where a CMF server (e.g., CMF server 214) can run locally to a node along with a client, or centrally, e.g., as an admin node or site (e.g., admin site 212) that is accessible by multiple clients. A CMF client can run on each participating node and observes the AI pipeline stage execution, and logs metadata, metrics, and artifacts in a local database. The tracking hierarchy associated with this distributed testing data processing stage can be reflected as “P→C3→E31,” with metadata/metrics/artifacts “m” being associated with execution unit or ID E31, and “P→C3→E32,” with metadata/metrics/artifacts “m” being associated with execution unit or ID E32. As can be appreciated, the testing data processing stage belongs to or is associated with the same data processing pipeline, P, as well as the same data processing stage, C3. However, given that the execution of this training data processing stage occurs at two different nodes/CMF clients, node 208/CMF client 208A and node 210/CMF client 210A, the tracking hierarchy reflects different, but related execution units or IDs, i.e., E31 and E32.

As alluded to above, generated hash content values may function as identifying keys/links that allow examples of the presently disclosed technology (including central repository, e.g., CMF server 214 associated with an admin site 212, to construct a data lineage representation for distributed data processing pipeline 202 and/or its constituent data artifacts. In other words, examples of the presently disclosed technology (including CMF server 214) may utilize the created hash content values to determine that e.g., the same data artifact (e.g., a first collected raw data artifact) is both an output of an execution of the raw data acquisition stage, and an input to an execution of the data processing stage—even when the two processing stages are performed by different individuals at different data processing sites (i.e., nodes 204 and 206, respectively).

The unique identification for related data artifacts provided by the hash content values of the presently disclosed technology plays a key role where such related data can beoperated on by multiple nodes or sites of a data processing pipeline. This is because in many cases, distributed data processing sites will e.g., (1) use different names/tags for the same data artifact/metadata/metric (i.e., a first data processing site may use a first name/tag for a first data artifact and a second data processing site may use a second name/tag for the (same) first data artifact); or (2) use the same/name tag for different data artifacts/metadata/metrics (i.e., a first data processing site may use a first name/tag for a first data artifact and a second data processing site may use the (same) first name/tag for a second (different) data artifact). By having the multiple data processing sites of a distributed data processing pipeline utilize the same hash algorithm/function for generating hash content values for data artifacts/metadata/metrics, examples may ensure that data artifacts/metadata/metrics are consistently named/identified across the multiple data processing sites. Such a common naming/identification scheme for data artifacts/metadata/metrics allows examples of the presently disclosed technology to construct data lineage representations for data processing pipelines (and/or their constituent data artifacts/metadata/metrics) more accurately and consistently than existing technologies.

Hash content values can be thought of as unique fingerprints for related data artifacts. Typically, a hash content value will be a string of numerical and/or alphabetic values that uniquely identifies related data. Hash content values may be generated using hash functions (e.g., cryptographic algorithms) which generate hash content values based on the content of the related data. Two common hash functions/algorithms for generating hash content values for related data are the MD5 and SHA1 algorithms.

Accordingly, a data processing site may utilize a hash function/algorithm to create/generate unique hash content values for each collected raw data artifact. In various examples, all the data processing sites (e.g., nodes 204-212 of distributed data processing pipeline 200) may utilize a common hash function/algorithm for creating hash content values. For example, nodes 204-212 may utilize the MD5 algorithm to create hash content values for data artifacts. Thus, a first hash content value (identifying, e.g., a first collected raw data artifact) created by node 204 may comprise the same numerical/alphabetic string as a corresponding hash content value (identifying the first collected raw data artifact) created by node 206. By contrast, a second hash content value (identifying, e.g., a second collected raw data artifact) created by node 204 may comprise a different numerical/alphabetic string than the first hash content value. As described above, by having the multiple data processing sites of a data processing pipeline utilize the same hash algorithm/function for generating hash content values for data artifacts, examples of the presently disclosed technology can ensure that data artifacts are consistently named/identified across multiple data processing sites. Such a common naming/identification scheme for data artifacts allows examples of the presently disclosed technology to construct accurate and complete data lineage representations for distributed data processing pipelines and/or their constituent data artifacts.

The metadata, for example, created by a node or data processing site for a given collected raw data artifact also includes an indication that the given collected raw data artifact (identified by the given collected raw data artifact's hash content value) was an output from a given execution of the raw data acquisition stage. Here, and as discussed above, nodes 204-212 may leverage a data processing pipeline tracking hierarchy to make this indication. As described above, the data processing pipeline abstraction hierarchy of the presently disclosed technology may comprise: (1) a data processing pipeline level P; (2) a processing stage level beneath the data processing pipeline level C; and (3) an execution level beneath the processing stage level E. Using this data processing pipeline abstraction hierarchy, examples may associate each data artifact of a data processing pipeline with (1) the given execution(s) associated with the input/output event(s); (2) the given processing stage(s) associated with the given execution(s); and (3) the given data processing pipeline associated with the given processing stage(s). As described above, based on these associations, examples of the presently disclosed technology may construct a data lineage representation for the given data processing pipeline and/or its constituent data artifacts.

Once collected/created, each of nodes 204-206 may export (1) the raw data artifacts, (2) the code used in executions for collecting the raw data artifacts, and (3) the metadata associated with collected raw data artifacts (and in some cases, the metadata associated with executions used to collect the raw data artifacts) to CMF server 214. As described above, exported metadata for a given collected raw data artifact may comprise: (1) a hash content value that identifies the given collected raw data artifact; (2) an indication that the given collected raw data artifact was an output of a given execution of the raw data acquisition stage; and (3) other metadata associated with the given collected raw data artifact. If CMF server 214 receives a hash content value for the first time, CMF server 214 may create a new metadata entry for the data artifact identified by the (newly encountered) hash content value. By contrast, when CMF server 214 has already encountered a hash content value before, CMF server 214 can merge the newly received metadata entry with one or more existing metadata entries associated with the data artifact identified by the previously encountered hash content value. In this way, CMF server 214 may stitch together both a data lineage representation and a metadata representation for the data artifact, and distributed data processing pipeline 202 as a whole.

Nodes 204-212 are, individually, at least intermittently connected to CMF server 214, which can be a central repository (e.g., a central datacenter, a GitHub, etc.). However (and importantly), nodes 204-212 need not be connected to each other (i.e., they may be distributed). Accordingly, nodes 204-212 may work independently from each other (and in some cases off-line) when performing their respective processing stages, and as noted above, may export their respective results to CMF server 214. Th

CMF server 214 may be a repository which is (logically) centrally located with respect to nodes 204-212, although CMF server 214 may be physically distributed, among e.g., nodes 204-212). Although not shown, it should be understood that CMF server 214 may comprise multiple sub-repositories such as a central artifact repository (e.g., a sub-repository for storing the data artifacts of distributed data processing pipeline 202). CMF server 214 may further comprise a central code repository (e.g., a central sub-repository for storing code used in executions of distributed data processing pipeline 202), as well as a central metadata repository, e.g., a central sub-repository for storing metadata associated with the data artifacts and executions of distributed data processing pipeline 202). In various examples, CMF server 214 may utilize Git as an index for the stored data artifacts, code, and metadata.

It should be understood that the above hashing methodology and tracking hierarchy follows a singleton design pattern with respect to the pipeline and stage/context aspects of the data processing pipeline. Singleton ensures that only one instance of a class exists throughout an application, while providing a global point of access to that instance. In other words, despite stages being supported/created by different nodes, given their hash content values can be the same, they can be merged. However, execution units/IDs are unique to the node/machine or data processing site on which the logic is run. That is, execution units/IDs are unique and tracked separately so that, as noted above, they have historical existence across multiple runs—these traditionally cannot be merged. Accordingly, and as illustrated in FIG. 2A, at admin site 212, after receipt of the metadata exported from nodes 204-212, the execution units and their corresponding metadata (E1, E2, and E4) can be aggregated or merged. That is, execution units/IDs E1, E2, and E4, each correspond to a single data processing stage/context (C1, C2, and C4, respectively), and their merger under pipeline P is allowed.

Referring now to FIG. 2B, and on the other hand, in accordance with a conventional FCMF framework, because execution units E31 and E32 are performed at different nodes, i.e., nodes 208 and 210, their metadata cannot be aggregated or merged. As discussed above, due to the hash/naming/identification methodology applied by conventional FCMF systems, and due to a desire to maintain historical data existence, the metadata associated with execution objects E31 and E32 cannot be merged.

For example, metadata generated during running of a single data processing pipeline stage can be scattered across different nodes, and can be associated with different unique execution IDs (or runflow IDs, depending on the particular FCMF framework used). Any effort to aggregate the metadata at CMF server 214 would result in multiple unique execution units representing a single run of a training or testing stage. No current solutions can automatically merge these independent execution units into one without manual intervention. Moreover, rerunning one experiment multiple times for performing active model engineering generates multiple such execution units (equal to decentralized learning nodes) each time, under the same stage, and thus, results in uncontrolled scaling of execution units. This makes metadata of each stage difficult to identify, track, compare and view globally. In fact, conventional FCMF or similar mechanisms are built to track a single run of a single stage via a unique execution ID. Development of such mechanisms are typically meant to integrate with other supporting database, visualization, and measurement tools (such as Neo4j, Tensor board, etc.) to provide an improved customer experience. However, any deviation from generating multiple executions units from a single stage run, in case of decentralized learning scenarios, may result in unexpected behaviors or even failure of conventionally-applied FCMF or similar tools.

However, and in accordance with examples of the presently disclosed technology, an empty execution pipeline or template can be distributed amongst nodes or data processing sites of a distributed data processing pipeline. As illustrated in FIG. 2B, instead of merely receiving artifacts at CMF server 214, the aforementioned empty execution pipeline/template can be pushed to nodes, e.g., nodes 204-212. The empty execution pipeline/template reflects an execution ID or object that is common to distributed nodes of training stages/contexts that are executed amongst two nodes, nodes 208 and 210. More generally, a single execution unit can be created for each execution run of a stage/context. Unlike the conventional FCMF implementation (show on the left-hand side of FIG. 2B), where execution units/objects are identified with unique execution IDs (E31/E32), execution units/objects can be identified with a common execution ID, E3 (as seen on the right-hand side of FIG. 2B). Correspondingly, when CMF server 214 receives the metadata from nodes 208 and 210 that perform(ed) the distributed training stage/context, the metadata is associated with a common execution ID, making the merging of the metadata associated with the distributed training possible. In this way, a unified view of a complete decentralized stage, in this case, training, runs across multiple nodes. As will be discussed in greater detail below, GIT-like push/pull mechanisms are allowed for, e.g., the sharing of certain information that would be globally useful, e.g., necessary but non-sensitive/private information from the nodes. This allows for the preservation of private information.

In some examples of the presently disclosed technology, an empty execution/tracking template or pipeline may comprise an SQL database, and individual instances of the SQL database can be pulled and populated by nodes. SQL databases can refer to relational databases/database design that provides a mechanism for storing/retrieving data modeled in some tabular relational fashion. For example, a CMF may leverage an SQLite database (a file-based relational database) to store pipeline and metadata-related information. In one example, a centralized CMF server running at an admin site may create an empty execution pipeline, stage and executions with unique ids that may get pulled by a CMF client present in each participating node (e.g. training node). During the execution of different stages (training, testing, etc.), CMF clients populate their respective local databases with their related metadata and performance metrics, for example. After the end of an execution, an SQLite file of each CMF client can be pushed to the centralized CMF server where they get merged (by the same execution id) to create a global view of the metadata and performance metrics. A merge function can also be user defined as described below. Although current CFM implementations use an SQLite relational database to persist tracking pipeline and metadata information, other databases or data stores can be leveraged. Any suitable database can be used (SQL, NoSQL etc.) or even JSON to store the details.

As noted above, a merge process can be user-defined. That is, FCMF provides “hooks” at different phases where users can plug in their own implementations. FCMF supports executing user-defined functions once metadata, for example, is pushed from CMF clients after execution of a stage ends. Default merging behavior may be just storing individual metadata or a result as part of one list. But the user-defined function can also be called by CMF clients with that list, where a user can decide how to merge those candidates. For example, a user can choose to determine averages, and return only a final average value as part of the merge process.

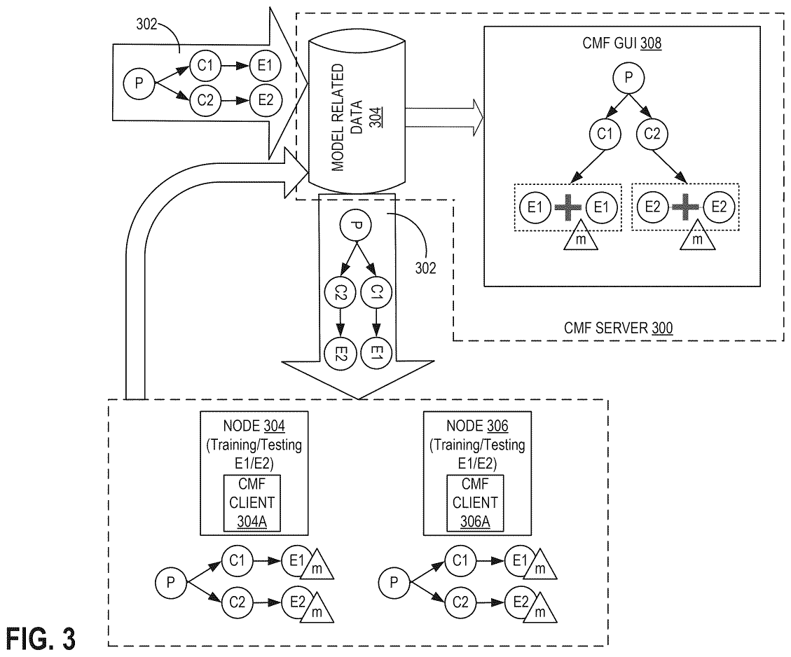

FIG. 3 illustrates an example functional flow illustrating operations that can be performed to achieve the above-described distributed data processing tracking hierarchy that allows for the merging of execution metadata regarding a single stage/context from distributed nodes. Again, a single execution unit can be created for each execution run of a stage/context. This single execution unit can then replicated to appropriate nodes/data processing sites and later, aggregated along with their respective metadata using a GIT-like push-pull mechanism. This approach ensures that even when a stage is divided and runs in a distributed fashion across multiple sites (e.g., decentralized training), all generated metadata and metrics can still be aggregated under a single execution ID at the central server. Moreover, this approach can be accomplished in accordance with CMF's tracking hierarchy: Pipeline (P)→Context (C)→Execution (E), where running a stage once as part of any experiment is represented by a single execution unit.

In accordance with some examples of the presently disclosed technology, CMF server 300 can be launched at an admin site (not shown in FIG. 3). CMF server 300 may be an embodiment of CMF server 214 (FIG. 2). Corresponding clients associated with CMF server 300 (CMF client 304A and CMF client 306A) may also be launched. A data processing pipeline tracking hierarchy can be created, e.g., by a user of an admin site at which CMF server 300 may be hosted or implemented, allowing each stage of the data processing pipeline to be tracked, and to allow for global assembly of executions. As discussed above, an empty execution pipeline or template may comprise a NoSQL database, and thus, an empty execution pipeline or template representative of the data processing tracking hierarchy that was created can be pushed to CMF server 300. Thus, the aforementioned GIT-like push-pull mechanism can be used to pull an empty execution pipeline from CMF server 300 to individual CMF clients (understanding that CMF clients are present on all training instances/nodes where an AI training pipeline runs).

In this example, the data processing pipeline tracking hierarchy reflects that nodes 304 and 306 are to perform executions of two stages/contexts. Accordingly, for a first stage to be performed at nodes 304 and 306, the data processing pipeline is P→C1→E1, and for a second stage to be performed at nodes 304 and 306, the data processing pipeline is P→C2→E2. In other words, the performance of two stages identified as C1 and C2 is to occur at each of nodes 304 and 306.

Nodes 304 and 306, before invoking ML training, may initialize their respective CMF clients, in this example, CMF clients 304A and 306A. This initialization comprises providing a CMF client (e.g., CMF clients 304A and 306A) with a CMF server (e.g., CMF server 300) address in order to establish communications (e.g., a communication channel) with the CMF clients. Clients 304A and 306A may each pull (using a GIT-like pull function), an empty execution template 302 that is representative of the created (global) distributed data processing tracking hierarchy from CMF server 300. It can be appreciated that the same execution IDs are used despite execution of stages C1 and C2 at different nodes, nodes 304 and 306. As explained above, the use of a common execution ID to reference execution objects/units originating from different nodes allows metadata associated with the common execution ID to be merged or aggregated.

During training, CMF clients 304A and 306A create new artifacts and metadata. CMF clients 304A and 306A may update the pulled empty execution template 302 locally with their locally-generated artifacts, metrics, and metadata. At the end of the training, nodes 304 and 306 can push the locally updated metadata, metrics, and artifacts to 300, all created under the common execution ID.

It should be understood that a model related data store 304 can be used to store or cache the empty execution template 302 after its creation, and from which CMF clients 304A/306A of nodes 304/306 can pull the empty execution template 302, and from where the empty execution template 302 can be pushed to CMF server 300. As also illustrated in FIG. 3, CMF clients 304A/306A of nodes 304/306 can, after local updating of the previously empty execution template 302, push their respective execution template 302 instances to model related data store 304. That is, and as illustrated in FIG. 3, node 304 may execute two stages, C1 and C2, and by virtue of that execution, may generate metadata/artifacts/metrics, m. Similarly, node 306 may also execute two stages, C1 and C2, and by virtue of that execution, may generate metadata/artifacts associated with their, local performance/execution of stages C1 and C2.

The now-populated execution template instances from CMF clients 304A/36A, including (in this example) the collected artifacts and metadata, can be pushed from nodes 304/306 to the CMF server 300 (via model related data store 304), where they can be easily merged under a single global execution. Additionally the sites hosting nodes 304 and 306 can track their respective artifacts, metrics, and metadata locally using a local CMF server and pushing only non-sensitive information to a central CMF server as explained above. That is, taking privacy into account in this example, CMF clients 304A and 306A can perform initialization and connect to a central FCMF server at an admin site (not shown). CMF clients 304A and 306A can pull empty execution templates from the central FCMF server. CMF clients 304A and 306A may re-initialize and connect to respective local CMF servers (not shown) on nodes 304 and 306, and CMF clients 304A/306A can log metadata, metrics, artifacts (as the case may be) during AI pipeline stage(s) execution. CMF clients 304A and 306A can push their respective related data to the local CMF servers, which in turn, can provide an “uncut” or complete view of all the related data local to the nodes (304 and 306). CMF clients 304A and 306A can again perform re-initialization to connect to the central FCMF to which their respective non-private related data (metadata, metrics, or artifacts) is pushed. The central FCMF server can collect the related data from all CMF clients to be merged, perform the merge, and provide a consolidated, global view of the non-private related data of the AI pipeline.

Ultimately, via a CMF GUI 308 (associated with CMF server 300), views or presentations, such as consolidated views of all artifacts and metadata collected during the execution of each stage, can be seen or observed by a user at the admin site. Here, it can be appreciated that the use of a single/common execution ID for both stages C1 and C2, allow for the metadata associated with the executions of stages C1 and C2 at nodes 304 and 306 to be merged (E1ₘ+E1ₘ and E2ₘ+E2ₘ).

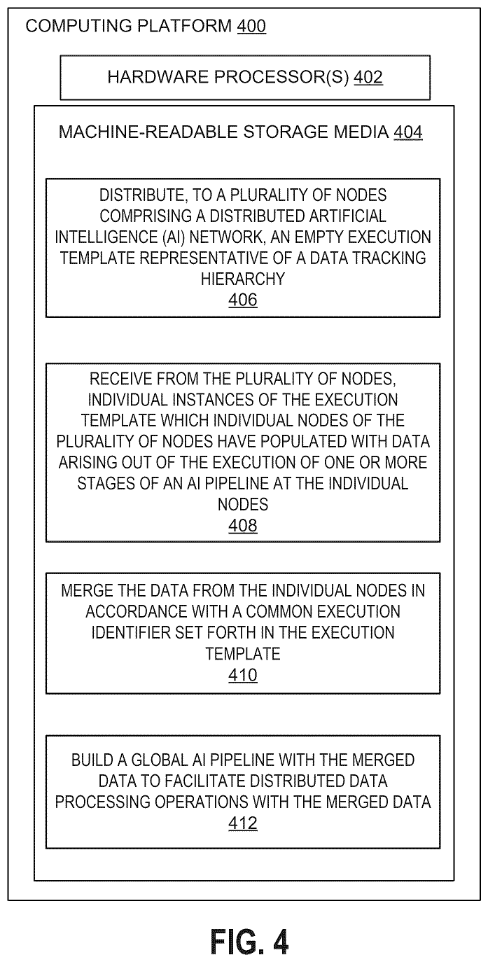

FIG. 4 depicts an example computing system that may be used to track metadata in a distributed data processing pipeline, in accordance with various examples of the presently disclosed technology.

Referring now to FIG. 4, computing component 400 may be, for example, a server computer, a controller, or any other similar computing component capable of processing data. In the example implementation of FIG. 4, the computing component 400 includes a hardware processor(s) 402, and machine-readable storage medium 406.

Hardware processor(s) 402 may be one or more central processing units (CPUs), semiconductor-based microprocessors, and/or other hardware devices suitable for retrieval and execution of instructions stored in machine-readable storage medium 404. Hardware processor(s) 402 may fetch, decode, and execute instructions, such as instructions 406-412, to control processes or operations for burst preloading for available bandwidth estimation. As an alternative or in addition to retrieving and executing instructions, hardware processor(s) 402 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 404, may be any electronic, magnetic, optical, or other physical storage device that contains or stores executable instructions. Thus, machine-readable storage medium 404 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 404 may be a non-transitory storage medium, where the term “non-transitory” does not encompass transitory propagating indicators. As described in detail below, machine-readable storage medium 404 may be encoded with executable instructions, for example, instructions 406-412.

As described above, computing system 400 may be used to effectuate metadata tracking for a distributed data processing pipeline executed across multiple data processing sites or nodes.

Accordingly, hardware processor(s) 402 may execute instruction 406 to distribute, to a plurality of nodes comprising a distributed artificial intelligence (AI) network, an empty execution template representative of a metadata tracking hierarchy. As explained above, CMF/FCMF systems utilize an abstraction hierarchy comprising Pipeline, Stage/Context, and Execution units or objects. Unlike conventional implementations of FCMF/CMF systems, the empty execution template, which can be a NoSQL database, comports with a labeling or naming convention wherein execution units or objects are commonly named, despite execution of one or more stages/contexts occurring amongst a plurality of nodes or data processing sites. In this way, the data processing pipeline abstraction hierarchy can be maintained, while allowing metadata associated with distributed execution units or objects to be merged.

Hardware processor(s) 402 may execute instruction 408 to receive from the plurality of nodes, individual instances of the empty execution template which individual nodes of the plurality of nodes have populated with metadata arising out of the execution of one or more stages of an AI pipeline at the individual nodes. The plurality of nodes may be operatively connected to a centralized CMF server. Following a client-server framework, the centralized CMF server can be initialized, and client instances of the CMF server can also be initialized at the individual nodes, facilitating operability with the centralized CMF server. That is, communications/interactions can be supported between nodes and the centralized CMF server to allow metadata/artifacts generated during the execution of stages to be passed to the centralized CMF server.

Hardware processor(s) 402 may execute instruction 410 to merge the metadata from the individual nodes in accordance with a common execution identifier set forth in the execution template. As noted above, the empty execution template follows a naming or identification convention whereby execution objects or units are commonly identified to allow for the metadata/artifacts associated with distributed execution of one or more stages or contexts to be merged. This is in contrast to conventional CFM/FCMF methods, where distributed stage executions across multiple nodes (to maintain historical data existence) are kept separate and distinct. Merging can be accomplished using a default or user-defined merge function(s).

Hardware processor(s) 402 may execute instruction 412 to build a global AI pipeline with the merged metadata to facilitate distributed data processing operations with the merged metadata. As described above, dependencies between processing stages and executions often arise in a data processing pipeline, which can affect performance metrics for ultimate/downstream output data artifacts of the data processing pipeline (e.g., datasets, ML models, etc.). Accordingly, it can be important to track metadata across a data processing pipeline to provide functionality like data lineage tracking, provenance and reproducibility. Relatedly, government regulations often require inspection of data artifacts (and/or executions) of a data processing pipeline when certain events occur (e.g., poor model performance, model bias, etc.). To perform regulatory (or non-regulatory) inspections, it can be advantageous to clone an entire data processing pipeline including its code, data artifacts, metadata, and dependencies in order to locally reproduce its execution for testing and debugging purposes.

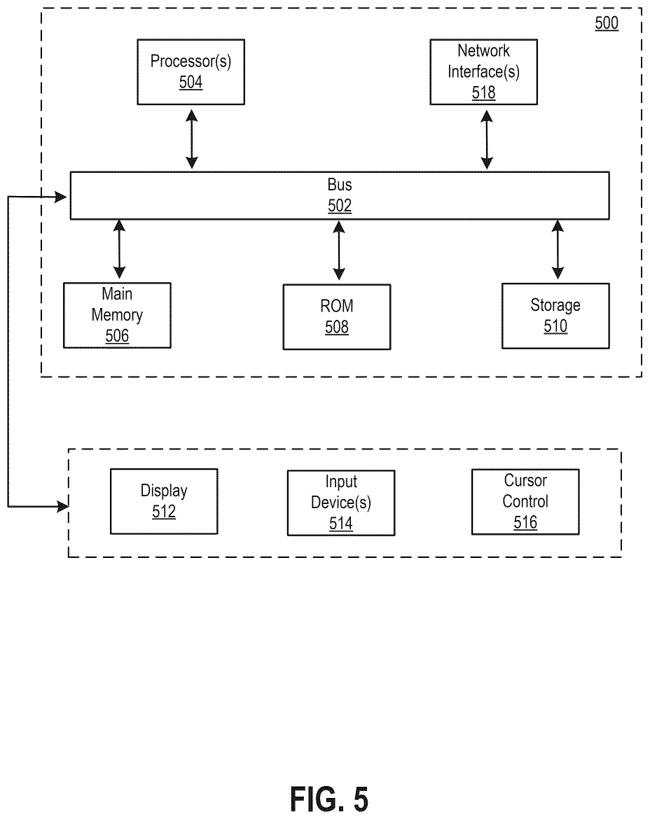

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors. Various aspects or elements/modules of the disclosed technology may be embodied as computer system 500, e.g., nodes 204-212, CMF clients 204A-212A, CMF server 214, etc.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. The computer system 500 may implement the techniques described herein using customized hard-wired logic, one or more ASICs or FPGAs, firmware and/or program logic which in combination with the computer system causes or programs computer system 500 to be a special-purpose machine.

The term “non-transitory media,” and similar terms, as used herein refers to any media that store data and/or instructions that cause a machine to operate in a specific fashion. Such non-transitory media may comprise non-volatile media and/or volatile media. Non-transitory media is distinct from but may be used in conjunction with transmission media. Transmission media participates in transferring information between non-transitory media.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical indicators that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
distributing, to a plurality of nodes comprising a distributed artificial intelligence (AI) network, an empty execution template representative of a data tracking hierarchy;
receiving from the plurality of nodes, individual instances of the execution template which individual nodes of the plurality of nodes have populated with data arising out of the execution of one or more stages of an AI pipeline at the individual nodes;
merging the data from the individual nodes in accordance with a common execution identifier set forth in the execution template; and
building a global AI pipeline with the merged data to facilitate distributed data processing operations with the merged data.

2. The method of claim 1, wherein the data tracking hierarchy comprises a pipeline level, one or more stage or context levels, and an execution level corresponding to each of the stage or context levels.

3. The method of claim 1, wherein the data comprises at least one of metadata, a metric, and an artifact.

4. The method of claim 3, wherein the at least one of the metadata, metric, and artifact comprises a hash content value that identifies the at least one of the metadata, metric, and artifact, and an indication that the at least one of the metadata, metric, and artifact was an output of or an input to a given execution of the one or more stages of the AI pipeline.

5. The method of claim 4, wherein the individual nodes utilize a common hash function or algorithm for creating the hash content value identifying the at least one of the metadata, metric, and artifact generated by the individual nodes.

6. The method of claim 5, wherein the distribution of the empty execution template is performed via a GIT-like pull mechanism transmitting the empty execution template from a centralized common metadata framework (CMF) server to the individual nodes.

7. The method of claim 6, wherein the GIT-like pull mechanism is supported pursuant to initialization of CMF clients hosted by the individual nodes, the initialization comprising providing an address of the CMF server to the CMF clients facilitating establishment of a communications channel between the CMF clients and the CMF server.

8. The method of claim 7, wherein the receipt of the individual instances of the empty execution template that are now populated with the data is performed via a GIT-like push mechanism transmitting the individual instances of the empty execution template from the individual nodes to the centralized CMF server.

9. The method of claim 8, further comprising creating, at the CMF server, a new entry for the at least one of the metadata, metric, and artifact, upon receipt of a newly encountered has content value.

10. The method of claim 8, wherein the merging of the data is prompted by receipt, at the CMF server, of a previously encountered hash content value, the merging of the data comprising occurring between two or more instances of the at least one of the metadata, metric, and artifact identified by a common has content value, one of which comprises the previously encountered hash content value.

11. The method of claim 10, wherein the merging of the data is performed using a default merge function or a user-defined merge function.

12. The method of claim 8, wherein the data arising out of the execution of one or more stages of an AI pipeline at the individual nodes comprises non-private data.

13. The method of claim 12, wherein private data arising out of the execution of one or more stages of an AI pipeline at the individual nodes is pushed to respective, local instances of the CMF server at the individual nodes prior to the CMF clients re-initializing with the CMF server to push the non-private data to the CMF server via the individual instances of the empty execution template that are now populated with the data.

14. A system, comprising:
a processor; and
a memory unit comprising instructions that when executed, cause the processor to:
receive, via instances of an execution template representing a tracking hierarchy, one or more of metadata, metrics, or artifacts generated by at least two nodes executing the same stage of an AI pipeline;
merging the one or more of the metadata, metrics, or artifacts from the at least two nodes in accordance with a common execution identifier set forth in the execution template; and
facilitating performance of global artificial intelligence (AI) model engineering based on the one or more of the merged metadata, metrics, or artifacts.

15. The system of claim 14, wherein the tracking hierarchy identifies a pipeline level, one or more stage or context levels, and an execution level corresponding to each of the stage or context levels.

16. The system of claim 14, wherein the one or more metadata, metrics, or artifacts comprises an identifying hash content value, and an indication that the one or more metadata, metric, or artifact was an output of or an input to the execution of the same stage of the AI pipeline.

17. The system of claim 16, wherein the at least two nodes utilize a common hash function or algorithm for creating the identifying hash content value.

18. The system of claim 14, wherein the receipt of the one or more metadata, metrics, or artifacts occurs via a GIT-like push mechanism.

19. A method, comprising:
launch a central common metadata framework (CMF) server at an admin site;
launch a plurality of CMF clients at nodes of a distributed artificial intelligence (AI) network;
provide to the CMF clients, instances of an execution template representative of an AI pipeline hierarchy;
receive from the CMF clients, the instances of the execution template populated with data generated by execution of one or more stages of an AI pipeline, wherein each execution of a stage of the one or more stages is represented in the execution template with a common execution identifier allowing the data generated by two or more of the plurality of CMF clients executing a common stage to be merged; and
building a global AI pipeline with the merged data.

20. The method of claim 19, wherein the data comprises at least one of metadata, metrics, and artifacts.
